(19) United States
(12) Patent Application Publication
(10) Pub. No.: US 2021/0009345 A1
(43) Pub. Date: Jan. 14, 2021

(54) Waste bag with integrated sanitizing wipe

(71) Applicant: Rochelle J. Crunk, Delray Beach, FL (US)

(72) Inventor: Rochelle J. Crunk, Delray Beach, FL (US)

(21) Appl. No.: 16/926,550

(22) Filed: Jul. 10, 2020

Related U.S. Application Data
(60) Provisional application No. 62/872,508, filed on Jul. 10, 2019.

(51) Int. Cl. B65F 1/00; B65F 7/00

(52) U.S. Cl. CPC B65F 1/0006; B65F 2240/136; B65F 1/0073; B65F 7/005

(57) ABSTRACT

The present invention is a waste bag with integrated sanitizing wipe. The waste bag with integrated sanitizing wipe provides a sanitary means of cleaning up pet waste, allowing the user to clean and disinfect their hands after cleaning up pet waste. The waste bag with integrated sanitizing wipe contains at least one waste bag and at least one sanitizing wipe. Each of the at least one waste bag contains a bag body, a bag opening, a waste cavity, a closed end. The bag opening and the closed end are terminally positioned opposite to each other along the bag body. The waste cavity is positioned within the bag body. The waste cavity is delineated by the bag opening. Each sanitizing wipe is removably attached adjacent to one of the at least one waste bag.

The current application claims a priority to the U.S. Provisional Patent application Ser. No. 62/872,508 filed on Jul. 10, 2019.

### FIELD OF THE INVENTION

The present invention relates generally to an apparatus for pet waste bags. More specifically, the present invention is an apparatus for a pet waste bag that includes a sanitation wipe for owners to clean their hands with after picking up waste.

### BACKGROUND OF THE INVENTION

Cleaning up pet waste is an unsanitary job. There is usually not an accessible place to wash hands when an owner is out with their pets and need to pick up their waste which is the law. This could inadvertently result in germs and pathogens spreading to hands therefore promoting illness and disease. Therefore, it is an objective of the present invention to provide a sanitary and accessible means to pick up pet waste.

The present invention contains a wipe conveniently attached or included with a pet waste bag to clean hands after waste pickup. The present inventor thought of this idea because one of their chihuahuas has gastrointestinal problems resulting in a foul smell. The present inventor takes him for a walk with the pet waste bag and a wipe for their hands. It makes the present inventor feel a lot more comfortable knowing that their hands are clean.

### SUMMARY OF THE INVENTION

The present invention is a waste bag with integrated sanitizing wipe. The waste bag with integrated sanitizing wipe comprises at least one waste bag and at least one sanitizing wipe. Each of the at least one waste bag comprises a bag body, a bag opening, a waste cavity, a closed end. The bag opening and the closed end are terminally positioned opposite to each other along the bag body. The waste cavity is positioned within the bag body. The waste cavity is delineated by the bag opening. Each sanitizing wipe is removably attached adjacent to one of the at least one waste bag.

### BRIEF DESCRIPTION OF THE DRAWINGS

FIG. 1 is a perspective view of the present invention.

FIG. 2 is a perspective view of the present invention, in accordance to another embodiment.

FIG. 3 is a perspective view of the present invention that shows at least one waste bag with integrated wipe being configured as a roll.

FIG. 4 is a perspective view of the present invention that shows at least one waste bag with integrated wipe being configured as a roll, where a waste bag with integrated wipe is unraveled.

FIG. 5 is a perspective view of the present invention that shows at least one waste bag with integrated wipe being configured to be folded adjacent along each other.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced or utilized without the implementation of some features as they are described. It should be understood that some details have not been described in detail in order to not unnecessarily obscure focus of the invention. References herein to “the preferred embodiment”, “one embodiment”, “some embodiments”, or “alternative embodiments” should be considered to be illustrating aspects of the present invention that may potentially vary in some instances, and should not be considered to be limiting to the scope of the present invention as a whole.

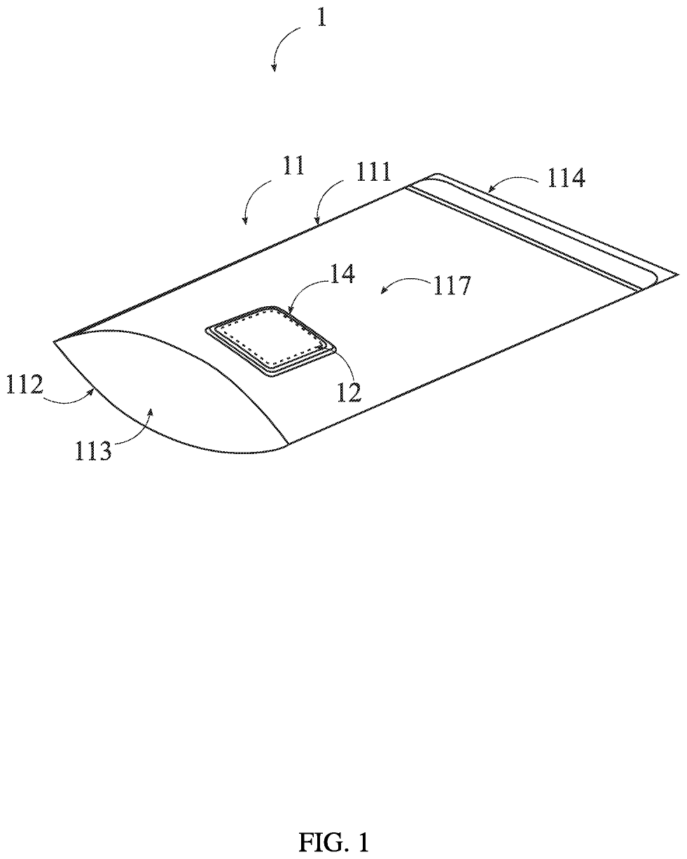

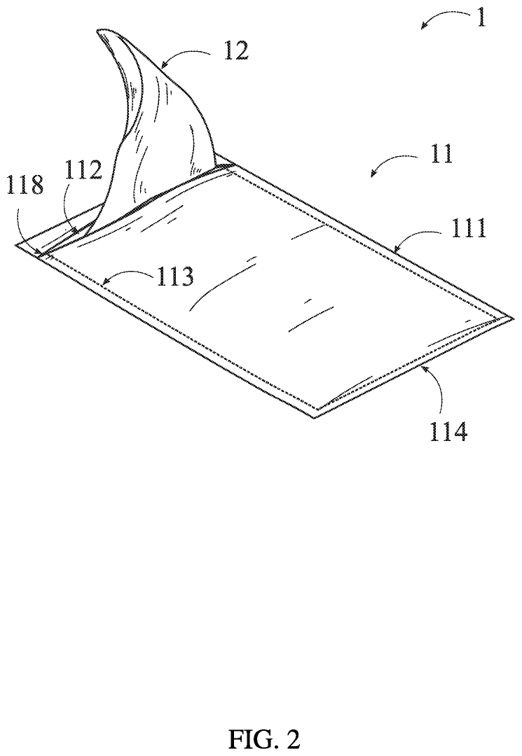

In reference to FIGS. 1-5, the waste bag with integrated sanitizing wipe 1 comprises at least one waste bag 11 and at least one sanitizing wipe 12. In reference to FIGS. 1-5, each of the at least one waste bag 11 comprises a bag body 111, a bag opening 112, a waste cavity 113, and a closed end 114. In reference to FIGS. 1-4, the bag opening 112 and the closed end 114 are terminally positioned opposite to each other along the bag body 111. In reference to FIGS. 1-2, the waste cavity 113 is positioned within the bag body 111. The waste cavity 113 is delineated by the bag opening 112. In the preferred embodiment of the present invention, each sanitizing wipe 12 is removably attached adjacent to one of the at least one waste bag 11. In the preferred embodiment of the present invention, the at least one waste bag 11 is made out of any suitable material such as, but not limited to plastic, plastic substitutes, biodegradable material, paper material or any other suitable material for containing pet waste. In the preferred embodiment of the present invention, the at least one sanitizing wipe 12 may take the form of an antibacterial wipe or wipe with cleaning solution that allows the user to sanitize and clean their hands of any animal refuse or debris after pet waste pickup and handling.

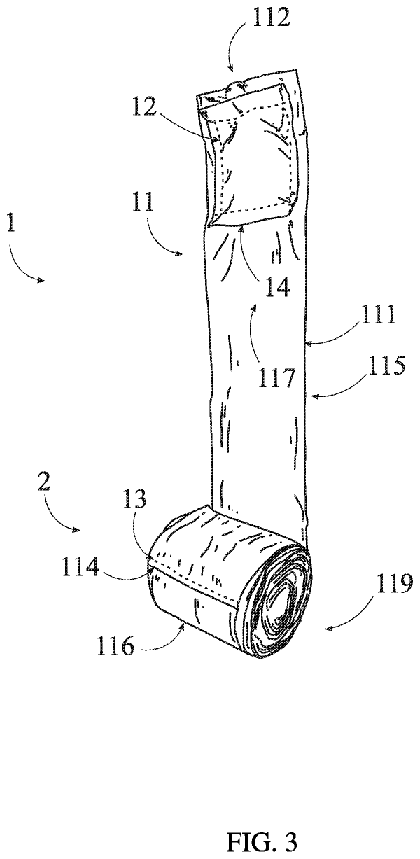

In reference to FIGS. 3-5, in some embodiments of the present invention, the waste bag with integrated sanitizing wipe 1 further comprises at least one perforation 13 and a sanitizing wipe pouch 14. In such embodiments, the at least one waste bag 11 further comprises an arbitrary waste bag 115 and an adjacent waste bag 116. The adjacent waste bag 116 is terminally and removably attached to the adjacent waste bag 116. The arbitrary waste bag 115 and the adjacent waste bag 116 are connected through one of the at least one perforation 13. In the preferred embodiment of the present invention, the at least one perforation 13 may take the form of a rip-able seam between the arbitrary waste bag 115 and the adjacent waste bag 116, allowing the user to easily separate the arbitrary waste bag 115 from the adjacent waste bag 116.

In reference to FIGS. 1 and 3-5, each of the at least one waste bag 11 comprises a mounting surface 117. The mounting surface 117 is externally positioned on the bag body 111. The sanitizing wipe is positioned within the sanitizing wipe pouch 14. The sanitizing wipe pouch 14 is removably attached adjacent to the mounting surface 117. The sanitizing wipe pouch 14 is removably attached to the mounting surface 117 through an adhesive. In the preferred embodiment of the present invention, the sanitizing wipe pouch 14 may take the form of a rip-able sealed packet that keeps the sanitizing wipe moist when not in use. In the preferred embodiment of the present invention, the adhesive may take the form of a suitable adhesive that allows the adhered sanitizing wipe pouch 14 to easily peel off the mounting surface 117 on the bag body 111. In another embodiment of the present invention, the mounting surface 117 is internally positioned on the bag body 111. The sanitizing wipe 12 is positioned within the sanitizing wipe pouch 14. The sanitizing wipe pouch 14 is removably attached adjacent to the mounting surface 117. The sanitizing wipe pouch 14 is removably attached to the mounting surface 117 through the adhesive.

In another embodiment of the present invention, each of the at least one waste bag 11 comprises a bag seal 118. The bag seal 118 is positioned adjacent to the bag opening 112, as shown in FIG. 2. The sanitizing wipe 12 is positioned within the waste cavity 113, where the sanitizing wipe 12 is accessible through opening of the bag seal 118. In this embodiment, the at least one waste bag 11 houses the sanitizing wipe such that the sanitizing wipe 12 keeps moist within the waste cavity 113. In this embodiment, the bag seal 118 may take the form of a rip-able seal that closes the bag opening 112, allowing the user to rip open the bag seal 118 to access the sanitizing wipe 12. The user can then insert their hand within the waste cavity 113, where the user can then proceed to pick up the pet waste and invert the waste bag 11 to contain the pet waste within the waste bag 11. The user can then utilize the sanitizing wipe 12, which is exposed to the external environment after inversion of the waste bag 11, to clean their hands.

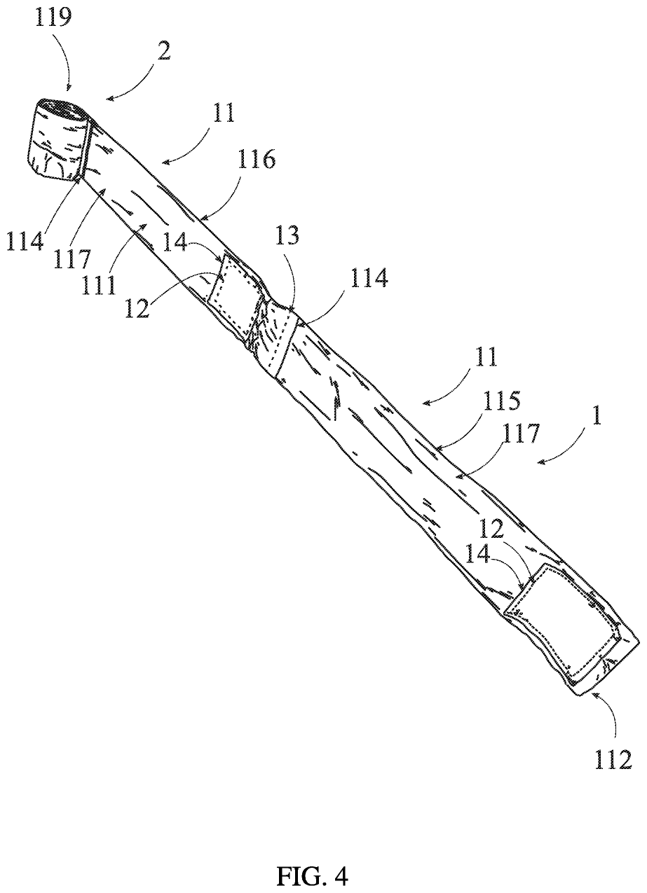

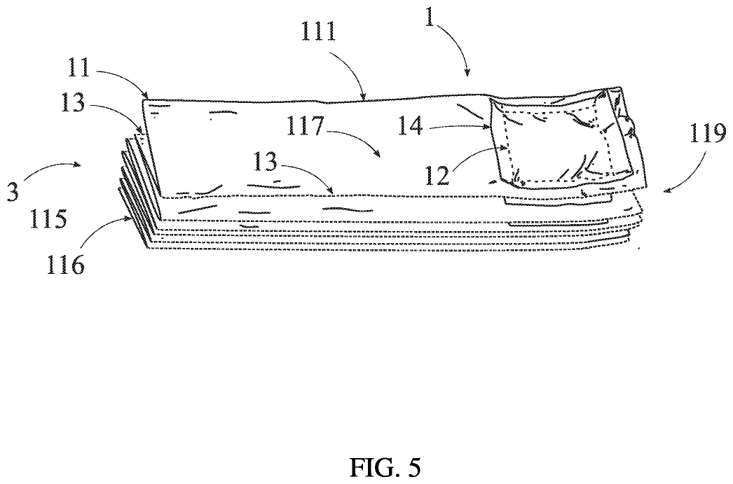

In reference to FIGS. 3-4, the at least one waste bag 11 comprises a plurality of waste bags 119, where the plurality of waste bags 119 is configured to be formed into a roll 2. In another embodiment of the present invention, the at least one waste bag 11 comprises the plurality of waste bags 119, and where the plurality of waste bags 119 is configured to be alternatingly folded adjacent to each other to form a folded bundle 3, as shown in FIG. 5. These configurations compartmentalize the plurality of waste bags 11 to fit into a backpack, pocket, purse, dispenser, or any other suitable receptacle.

Although the invention has been explained in relation to its preferred embodiment, it is to be understood that many other possible modifications and variations can be made without departing from the spirit and scope of the invention as hereinafter claimed.

What is claimed is:

1. A waste bag with integrated sanitizing wipe comprising:
at least one waste bag;
at least one sanitizing wipe;
each of the at least one waste bag comprising a bag body, a bag opening, a waste cavity, a closed end;
the bag opening and the closed end being terminally positioned opposite to each other along the bag body;
the waste cavity being positioned within the bag body;
the waste cavity being delineated by the bag opening; and
each sanitizing wipe being removably attached adjacent to one of the at least one waste bag.

2. The waste bag with integrated sanitizing wipe as claimed in claim 1 comprising:
the at least one waste bag comprising an arbitrary waste bag and an adjacent waste bag; and
the adjacent waste bag being terminally and removably attached to the adjacent waste bag.

3. The waste bag with integrated sanitizing wipe as claimed in claim 2 comprising:
at least one perforation; and
the arbitrary waste bag and the adjacent waste bag being connected through one of the at least one perforation.

4. The waste bag with integrated sanitizing wipe as claimed in claim 1 comprising:
a sanitizing wipe pouch;
each of the at least one waste bag comprising a mounting surface;
the mounting surface being externally positioned on the bag body;
the sanitizing wipe being positioned within the sanitizing wipe pouch;
the sanitizing wipe pouch being removably attached adjacent to the mounting surface; and
the sanitizing wipe pouch being removably attached to the mounting surface through an adhesive.

5. The waste bag with integrated sanitizing wipe as claimed in claim 1 comprising:
a sanitizing wipe pouch;
each of the at least one waste bag comprising a mounting surface;
the mounting surface being internally positioned on the bag body;
the sanitizing wipe being positioned within the sanitizing wipe pouch;
the sanitizing wipe pouch being removably attached adjacent to the mounting surface; and
the sanitizing wipe pouch being removably attached to the mounting surface through an adhesive.

6. The waste bag with integrated sanitizing wipe as claimed in claim 1 comprising:
each of the at least one waste bag comprising a bag seal;
the bag seal being positioned adjacent to the bag opening; and
the sanitizing wipe being positioned within the waste cavity, wherein the sanitizing wipe is accessible through opening of the bag seal.

7. The waste bag with integrated sanitizing wipe as claimed in claim 1, wherein the at least one waste bag comprises a plurality of waste bags, and wherein the plurality of waste bags is configured to be formed into a roll.

8. The waste bag with integrated sanitizing wipe as claimed in claim 1, wherein the at least one waste bag comprises a plurality of waste bags, and wherein the plurality of waste bags is configured to be alternatingly folded adjacent to each other.
